(19) United States
(12) Patent Application Publication
(10) Pub. No.: US 2002/0196180 A1
(43) Pub. Date: Dec. 26, 2002

(54) GPS for high altitude satellites

(76) Inventor: Min-I James Chang, Herndon, VA (US)

Correspondence Address: Min-I James Chang, P.O. Box 5283, Herndon, VA, 20172-1978, US

(21) Appl. No.: 09/891,444

(22) Filed: Jun. 25, 2001

(51) Int. Cl. G01S 5/14

(52) U.S. Cl. 342/357.06

(57) ABSTRACT

A Method provides GPS signals to high altitude such as geostationary earth orbit GPS users. A GPS signal Generator system (10), GPS satellite position (20), designated High altitude GPS user locations (30), a GPS broadcast antenna control system (40), an antenna control mechanism (50), earth pointing GPS signal broadcast antenna (60) and high altitude GPS broadcast antenna/antennas (65) are integrated to provide GPS signals to designated high altitude locations.

### BACKGROUND OF THE INVENTION

1. Field of Invention

This is an innovated “GPS signal for high altitude Satellites” technique using an antenna control system that points GPS broadcast antenna to the designated high altitude satellite locations.

2. Description of the Related Art

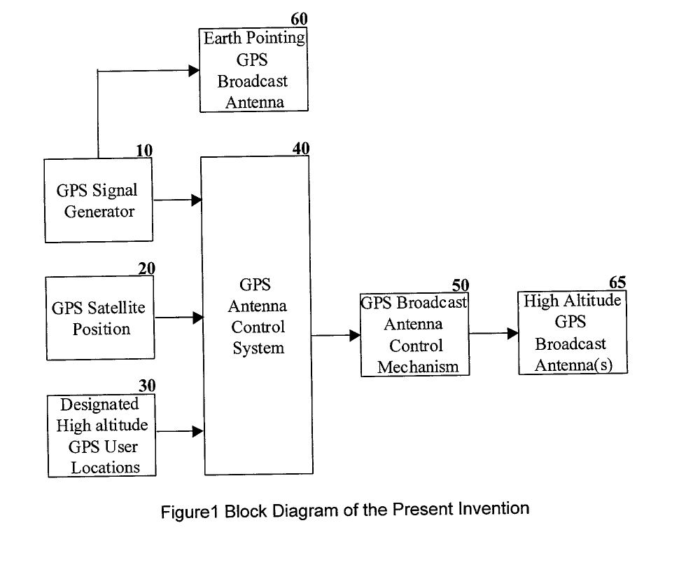

The current GPS satellites only have a broadcast antenna pointing to earth. The latest analyses of high-altitude satellite assume the GPS broadcast beam is a right circular cone with a 23.5-degree half angle directed at the earth's center. From the altitude of the GPS satellites, this 23.5-degree cone is about 9 degrees wider than the earth, and thus some of the energy broadcast by each GPS satellite spills past the planet into space (see FIG. 1). The otherwise wasted signal energy is the current basis for navigation of high altitude satellites. The problems of the current GPS signals for high altitude satellite GPS users are limited GPS Satellite visibility, low GPS signal power and GPS Coverage Gap. The use of GPS interconnection signal, the use of GPS side lode signals and the use of fixed GPS antenna on the backside of the GPS satellite transmitting GPS signals were considered for high altitude GPS users. All the existing approaches for using GPS signals at high altitude have GPS signal quality, GPS signal availability and GPS coverage problems.

### OBJECTS AND ADVANTAGES

Accordingly, several objects and advantages of my invention are to provide GPS signals to some designated high altitude satellites with better GPS signal availability, better GPS signal strength and better GPS coverage.

### BRIEF SUMMARY OF THE INVENTION

The present invention uses an additional GPS antenna/antennas pointing to outer space to provide GPS signals to high altitude GPS users. In one embodiment, a single broadcast antenna pointing to outer space is used in the present invention. In the other embodiment, multiple broadcast antennas pointing to outer space is used in the present invention. A GPS antenna pointing control system controls the GPS signal broadcast antenna/antennas orientation such that it points to designated locationds. FIG. 1 depicts the block diagram of a preferred embodiment of the present invention in providing GPS signals to high altitude GPS users. A GPS signal Generator system (10), GPS satellite position (20), designated High altitude GPS user locations (30), a GPS broadcast antenna control system (40), an antenna control mechanism (50), earth pointing GPS signal broadcast antenna (60) and high altitude GPS broadcast antenna/antennas (65) are integrated to provide GPS signals to designated high altitude locations.

### DETAILED DESCRIPTION

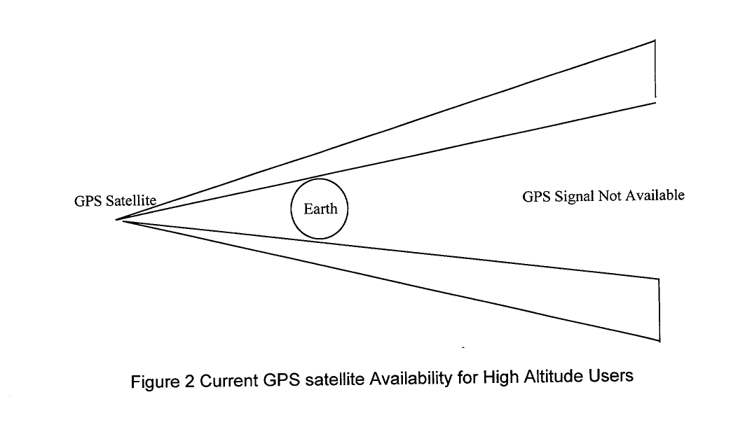

The current GPS satellites have a broadcast antenna pointing to earth. The current GPS satellites do not have any antenna pointing to outer space. The latest analyses of high-altitude satellite assume the GPS broadcast beam is a right circular cone with a 23.5-degree half angle directed at the earth's center. From the altitude of the GPS satellites, this 23.5-degree cone is about 9 degrees wider than the earth, and thus some of the energy broadcast by each GPS satellite spills past the planet into space (see FIG. 2). The otherwise wasted signal energy is the current basis for navigation of high altitude satellites. The problems of the current GPS signals for high altitude satellite GPS users are:

Limited GPS Satellite Visibility—The current GPS navigation system is designed for near earth GPS users. The broadcast antenna of the GPS satellites points to earth. If altitude of the GPS user is higher than the GPS satellites, the high altitude GPS user can only receive GPS signal that is transmitted from a GPS satellite the other side of earth. The number of visible GPS satellite is significantly reduced when the distance between satellite and earth is increase more than 5 times of earth radius. Assuming a nominal 24 satellite GPS constellation with no satellite outages, the average number of GPS satellites available to a high altitude satellite such as geostationary earth orbit (GEO) satellite is 1 GPS satellite at any given moment. In addition, the visible GPS satellite of a GEO satellite GPS user is on the other side of earth.

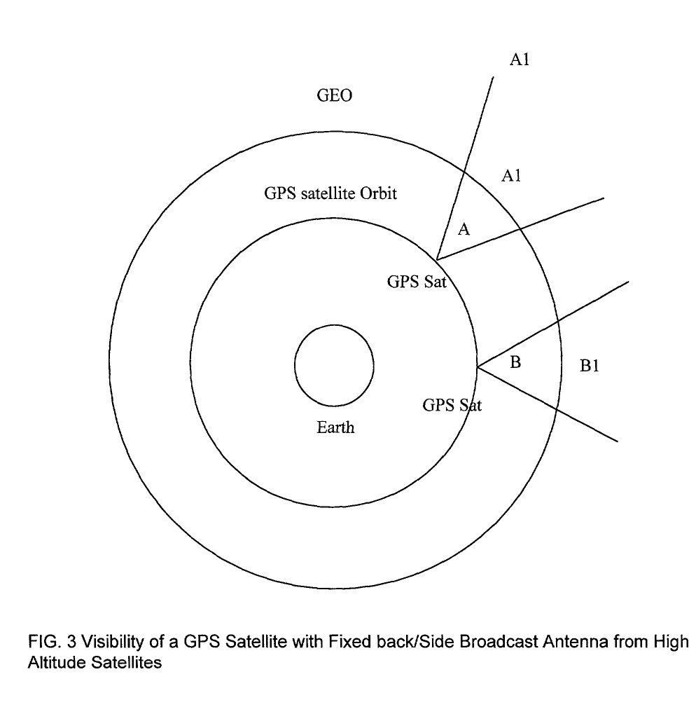

Low GPS Signal Power—A high altitude satellite such as GEO satellite never passes directly below GPS signals that spill over the limb of the earth as depicted in FIG. 3. The GPS satellite visible to a GEO satellite is only when the GPS satellite is on the other side of earth. GPS signals arriving in this manner travel a distance of more than 60,000 kilometer. The GPS signal power is greatly reduced, between −164 to −182 dBW, due to the great separation distance. The weakness of the GPS signal for high altitude satellite GPS user demand a challenge and unique RF front end design for each high altitude satellite GPS users.

GPS Coverage Gap—In addition to weak GPS signal, the gap of GPS signal coverage is also a problem for tracking GPS satellites over the earth' limb at high altitude such as GEO satellite. The gaps of no GPS signal may be as long as two hours.

Three options were considered to improve the GPS signals availability for high altitude GPS users

Use of Side-lobe Signals—Although the energy emitted by way of the GPS broadcast antenna side lobes may be able for navigation. The antenna's primary beam must provide a specific signal power distribution that guarantees a minimum received GPS signal strength of −160 dBW for the L1, C/A code at near earth's surface with a wave front of uniform carrier phase. However, there is no specified requirement for GPS side lobe signals. The problem of the side-lobe approach is that the strength or phasing of the received signal could not be assured. There are, however, some significant technical problems associated with the side-lobe signals.

Use of Fixed Backside antennas—Adding a broadcast antenna to the GPS satellites that points in the radically-outward direction. Although this approach increase the GPS signals availability to high altitude GPS user, FIG. 3 shows the number of visible GPS signals from the backside antenna broadcast is still limited. The high altitude satellite sat Al can only receive GPS signal from GPS satellite A. Similarly, the high altitude satellite sat B1 can only receive GPS signal from the backside broadcast antenna of the GPS satellite B. The GPS satellite signal broadcast from GPS satellite fixed backside broadcast antenna A can not reach to the high altitude satellite B1. Therefore, the availability and coverage gap of GPS signal to GEO satellite are still a problem, if a fixed backside GPS antenna is used to transmit GPS signals to the GEO satellite location.

The use of GPS interconnection signal—The signal availability and coverage gap are concerned.

All the above three approaches that provide GPS signals to high altitude GPS users have weak GPS signal strength, low GPS signal availability and GPS coverage gap problem. It is very desirable to provide GPS signals to high altitude GPS users with good GPS signal strength, good GPS signal availability and good GPS coverage.

Therefor there is a need in the technology to provide a method such that the high altitude GPS user will have good GPS availability and signal strength.

The present invention, as shown in FIG. 1, proposes an approach that provides GPS signals to high altitude outer space satellite. The present invention uses an antenna control system to point the back/side mounted GPS broadcast antenna/antennas to achieve the following goals:

To provide GPS signals to the designated outer space locations.

To minimize GPS signal transmission power to outer space users.

To maximize GPS signal strength for outer space GPS users.

To maximize the number of outer space location that can receive GPS signals.

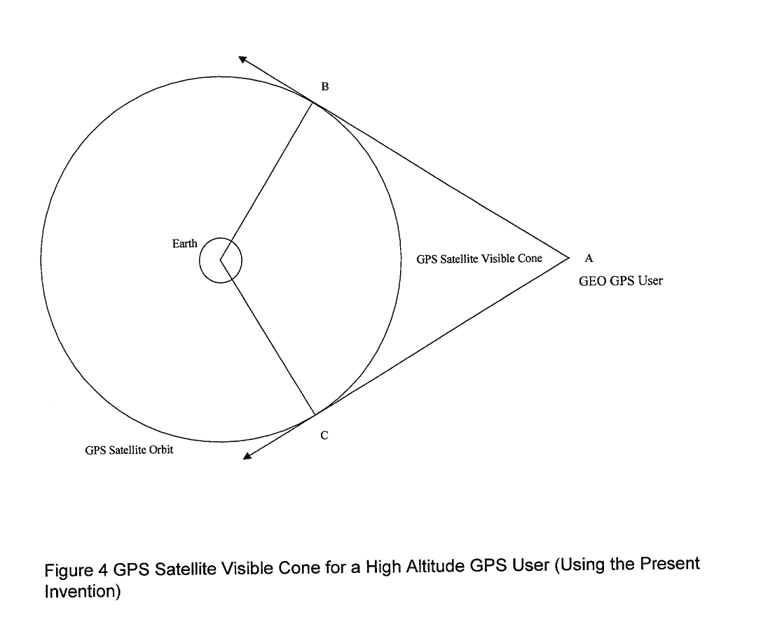

To accomplish these goals for providing GPS signals to high altitude satellites such as GEO satellites, the present invention proposes to add an antenna control system and an additional GPS broadcast antenna (or multiple antennas) to the GPS satellites. The additional GPS broadcast antenna/antennas are mounted on the back/side panel of the GPS satellite. The orientation of the additional GPS broadcast antenna/antennas is controlled by a control system. The control system determines which antenna is used to broadcast GPS signals, if multiple antennas are used. The control mechanism controls the pointing direction of the GPS broadcast antenna/antennas using the position/velocity of the GPS satellite and the designated high altitude satellites. FIG. 4 shows the GPS satellites visible cone from a GEO satellite for the present invention. Any GPS satellites within the cone BAC are visible to the GEO satellite at A. with the assumption of 24 GPS satellites, the average number visible GPS satellites is about 4.6. All these visible GPS satellite are within 41,000 kilometers from the GEO satellite position and the average of 2.5 satellites are within 20,000 kilometers from the GEO satellite position. In other word, a GEO satellite has 2.5 GPS visible GPS satellite with the same or better GPS signal strength as the near earth GPS users. It is note that there are 3.3 visible GPS satellites are within 20,000 kilometers for some GEO satellite position. FIG. 4 is only for exemplary in nature and is no way intended to limit the invention or its applications or uses.

### CONCLUSIONS, RAMIFICATIONS AND SCOPE

Accordingly, it can be seen that the reader will see that I have provided a method of transmitting GPS signals to high altitude satellite GPS users with better GPS signal availability, GPS signal strength and GPS coverage.

Although the description above contains specificity, these should not be construed as limiting the scope of the invention but as merely providing illustrations of some of the presently preferred embodiments of this invention. Various other embodiments and ramifications are possible within it's scope.

Thus the scope of the invention should be determined by the appended claims and their legal equivalents, rather than by the examples given.

What is claimed is:

1. A method for transmitting GPS signals for high altitude satellite GPS users

2. The system includes a GPS signal generation system, multiple GPS broadcast antennas, an antenna control system and antenna control mechanism.

3. One antenna is mounted on the satellite panel pointing to earth for transmitting GPS signal to earth. The other antenna is (or multiple antennas are) mounted on the antenna control mechanism for transmitting GPS signal to outer space.

4. The antenna control mechanism is mounted on the back/side panel of GPS satellites.

5. The GPS broadcast antenna control system uses the position (with/without velocity) of the GPS satellite and the designated high altitude satellites to select antenna/antennas, if multiple broadcast antennas are used.

6. The GPS broadcast antenna control system uses the position (with/without velocity) of the GPS satellite and the designated high altitude satellites to determination the pointing direction of the GPS outer space broadcast antenna/antennas.

7. The antenna control mechanism receives the command from the antenna control system to point the antenna, described in 3, to the desired orientation.

8. The antenna is selected by the antenna control system to point the antenna to a designated high altitude satellite location, if multiple antennas are used.

9. The GPS satellites provide GPS signals to multiple high altitude satellites.
